(19) United States
(12) Patent Application Publication
(10) Pub. No.: US 2009/0273583 A1
(43) Pub. Date: Nov. 5, 2009

(54) CONTACT SENSITIVE DISPLAY

(75) Inventor: Bjorn NORHAMMAR, Stocksund (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/119,662

(22) Filed: May 13, 2008

Related U.S. Application Data
(60) Provisional application No. 61/050,389, filed on May 5, 2008.

(51) Int. Cl. G06F 3/043

(52) U.S. Cl. 345/177

(57) ABSTRACT

An assembly may include a touch screen. A first element may be provided to cause the touch screen to vibrate at a predetermined frequency. A first sensor proximate to a first portion of the touch screen may measure vibration in the first portion of the touch screen. A second sensor proximate to a second portion of the touch screen may measure vibration in the second portion of the touch screen. Position sensing logic may determine a position of a contact point on the touch screen based on the measured vibration in the first portion of the touch screen and the measured vibration in the second portion of the touch screen.

### CROSS-REFERENCE TO RELATED APPLICATION

The present application claims priority from U.S. Provisional Patent Application No. 61/050,389, filed May 5, 2008, the disclosure of which is incorporated by reference herein in its entirety.

### BACKGROUND OF THE INVENTION

Implementations described herein relate generally to input devices, and more particularly, to handheld input devices that are responsive to various types of direct or indirect contact.

Devices, such as handheld mobile communication devices or media playback devices, conventionally include input devices for receiving commands from a user. Conventional input devices generally include a keypad formed of physically distinct keys. More recently, input devices have been configured to include touch sensitive displays that are reconfigurable based on an application executing on the device. Known touch sensitive displays utilize resistive or capacitive sensing technology to determine the touched location on the display.

Unfortunately, known touch sensitive display technologies do not provide for a robust, accurate, flexible, and damage-resistant display. In addition, known touch sensitive displays typically reduce light/color and add considerable thickness to the display.

### SUMMARY OF THE INVENTION

According to one aspect, an assembly may include a touch screen; a first element to cause the touch screen to vibrate at a predetermined frequency; a first sensor proximate to a first portion of the touch screen for measuring vibration in the first portion of the touch screen; a second sensor proximate to a second portion of the touch screen for measuring vibration in the second portion of the touch screen; and position sensing logic for determining a position of a contact point on the touch screen based on the measured vibration in the first portion of the touch screen and the measured vibration in the second portion of the touch screen.

Additionally, the first element causes the touch screen to emit an acoustic signal in response to the vibrating at the predetermined frequency, and where the first sensor and the second sensor comprise microphones for monitoring the acoustic signal.

Additionally, the first element comprises a piezo-electric element configured to deform based on a control signal.

Additionally, the first sensor and the second sensor comprise piezo-electric elements configured to output signals based on deformation caused by the vibration of the touch screen.

Additionally, the touch screen further includes a display screen; an enclosure that contains a liquid and the first element; and a touch sensitive cover, where the first sensor and the second sensor are provided proximate to respective portions of the touch sensitive cover.

Additionally, the assembly includes a third sensor and a fourth sensor, where the touch screen is provided in a substantially rectangular configuration and where the first sensor, second sensor, third sensor, and fourth sensor are provided proximate to corners of the touch screen.

Additionally, the first element produces an ultrasonic wave through the liquid to vibrate the touch sensitive cover at the predetermined frequency.

Additionally, the position sensing logic is further configured to determine a position of a contact point on the touch sensitive cover.

Additionally, the position sensing logic is further configured to output a signal to processing logic based on the determined position of the contact point on the touch sensitive cover.

According to another aspect, a method may be provided. The method may include causing a touch screen to vibrate at a predetermined frequency; monitoring changes in vibration at a first portion of the touch screen and a second portion of the touch screen; and determining a location of a contact on the touch screen based on the monitored changes.

Additionally, causing a touch screen to vibrate at a predetermined frequency may include receiving a command to activate an ultrasonic element associated with the touch screen; and activating the ultrasonic element in response to the command.

Additionally, the ultrasonic element includes a piezo-electric element.

Additionally, the predetermined frequency causes the touch screen to emit an acoustic signal, and where the monitoring changes in vibration at a first portion of the touch screen and a second portion of the touch screen further includes monitoring changes in the acoustic signal at the first portion and the second portion.

Additionally, monitoring changes in vibration at a first portion of the touch screen and a second portion of the touch screen further includes coupling a first sensor proximate to the first portion; coupling a second sensor proximate to the second portion; deflecting the first sensor and the second sensor based on the vibration of the touch screen; and outputting signals based on the deflecting of the first sensor and the second sensor.

According to yet another aspect, a device may include a display assembly comprising: a display screen; an enclosure that contains a liquid; a top surface provided in contact with the enclosure; an ultrasonic element provided within the enclosure; and a plurality of ultrasonic sensors located proximate to portions of the top surface; and logic configured to: activate the ultrasonic element to produce a vibration in the top surface via the liquid; monitor vibration of the portions of the top surface by the sensors; determine a location of a contact on the top surface based on the monitored vibration; and use the determined location to interact with the device.

Additionally, the vibration in the top surface causes the top surface to output an acoustic signal, and where the plurality of ultrasonic sensors further comprise a plurality of microphones configured to monitor changes in the acoustic signal output by the top surface.

Additionally, the ultrasonic element includes a piezo-electric element.

Additionally, the plurality of ultrasonic sensors include a plurality of piezo-electric sensors.

Additionally, the top surface includes a substantially rectangular configuration and where the plurality of ultrasonic sensors further include a first sensor provided proximate a first corner of the top surface; a second sensor provided proximate a second corner of the top surface; a third sensor provided proximate a third corner of the top surface; and a fourth sensor provided proximate a fourth corner of the top surface.

Additionally, the logic is further configured to determine the location of one or more points of contact on the top surface based on the vibration monitored by the first sensor, the second sensor, the third sensor, and the fourth sensor.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 is a diagram of an exemplary implementation of a mobile terminal;

FIG. 2 illustrates an exemplary functional diagram of a mobile terminal;

FIG. 3 illustrates an exemplary functional diagram of the touch screen logic of FIG. 2;

FIG. 4 illustrates an exemplary touch screen assembly; and

FIG. 5 is a flowchart of exemplary processing.

### DETAILED DESCRIPTION OF THE INVENTION

The following detailed description of the invention refers to the accompanying drawings. The same reference numbers in different drawings may identify the same or similar elements. Also, the following detailed description does not limit the embodiments.

Exemplary implementations of the embodiments will be described in the context of a mobile communication terminal. It should be understood that a mobile communication terminal is an example of a device that can employ a keypad consistent with the principles of the embodiments and should not be construed as limiting the types or sizes of devices or applications that can use implementations of keypads described herein. For example, keypads consistent with the principles of the embodiments may be used on desktop communication devices, household appliances, such as microwave ovens and/or appliance remote controls, automobile radio faceplates, televisions, computer screens, industrial devices, such as testing equipment, etc.

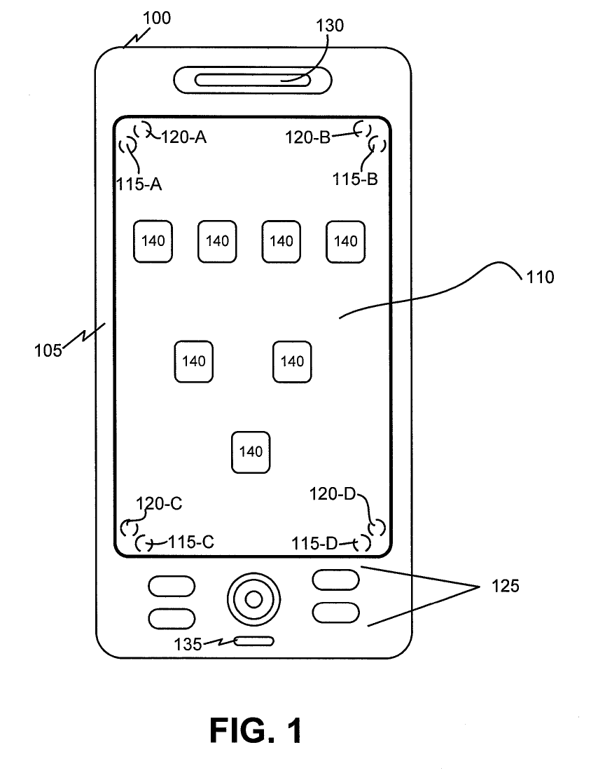

FIG. 1 is a diagram of an exemplary implementation of a mobile terminal consistent with the principles of the invention. Mobile terminal 100 (hereinafter terminal 100) may be a mobile communication device. As used herein, a “mobile communication device” and/or “mobile terminal” may include a radiotelephone; a personal communications system (PCS) terminal that may combine a cellular radiotelephone with data processing, a facsimile, and data communications capabilities; a personal digital assistant (PDA) that can include a radiotelephone, pager, Internet/intranet access, web browser, organizer, calendar, and/or global positioning system (GPS) receiver; and a laptop and/or palmtop receiver or other appliance that includes a radiotelephone transceiver.

Terminal 100 may include a housing 105, a touch screen 110, ultrasonic emitters 115-A to 115-D (collectively, “ultrasonic emitters 115” and individually “ultrasonic emitter 115”), ultrasonic sensors 120-A to 120-D (collectively, “ultrasonic sensors 120” and individually “ultrasonic sensor 120”), control keys 125, speaker 130, and microphone 135. Housing 105 may include a structure configured to hold devices and components used in terminal 100. For example, housing 105 may be formed from plastic, metal, or composite and may be configured to support touch screen 110, ultrasonic emitters 115, ultrasonic sensors 120, control keys 125, speaker 130, and microphone 135.

Touch screen 110 may include devices and/or logic that can be used to display images to a user of terminal 100 and to receive user inputs in association with the displayed images. For example, icons, virtual keys, or other graphical elements (depicted generally as graphical elements 140 in FIG. 1) may be displayed via touch screen 110. For example, touch screen 110 may provide information associated with incoming or outgoing calls, text messages, games, phone books, the current date/time, volume settings, etc., to a user of terminal 100.

Implementations of touch screen 110 may be configured to receive a user input when the user interacts with graphical elements 140 displayed thereon. For example, the user may provide an input to touch screen 110 directly, such as via the user's finger, or via other devices, such as a stylus, etc. In other implementations, user input may be received irrespective of a particular set or group of graphical elements 140 displayed therein. Consistent with embodiments described herein, user interaction with touch screen 110 may not be limited to particular types of materials, such as a user's bare skin, or a plastic or metal stylus. User inputs received via touch screen 110 may be processed by components or devices operating in terminal 100 and will be described in additional detail below.

In one implementation, touch screen 110 may include a display that may display graphical elements 140. In other implementations, touch screen 110 may be covered by a single plate of glass, plastic or other material which covers the display. The display may include a black and white or color display, such as liquid crystal display (LCD). Implementations of various graphical elements 140 may include key or icon information associated therewith, such as numbers, letters, symbols, images, etc. A user may interact with graphical elements 140 to input information into terminal 100. For example, a user may select particular graphical elements 140 to enter digits, letters, commands, and/or text, into terminal 100. Alternatively, a user may interact with an application executing on terminal 100 via touch screen 110, such as to open an application, select an item, play a game, etc. In other implementations, terminal 100 may include separate touch screen and non-touch screen display portions, where the non-touch screen display portion may display imagery and/or keypad elements that are not directly interacted with by the user.

As will be described in additional detail below, touch screen 100 may include one or more ultrasonic emitters 115 and ultrasonic sensors 120 associated therewith for use in determining one or more contact locations on touch screen 100. More specifically, each ultrasonic emitter 115 may emit an ultrasonic signal to touch screen 110 resulting in vibration or oscillation of touch screen 110. Ultrasonic sensors 120 may sense changes in vibration of touch screen 110 to determine the one or more contact areas on touch screen 110. In one implementation, ultrasonic emitters 115 may include piezo-electric transducers configured to generate precise ultrasonic signals within a material, such as touch screen 110. Ultrasonic sensors 120 may also include piezo-electric elements configured to sense the vibration of touch screen 110. In another implementation, ultrasonic sensors 120 may include other types of vibration sensors, such as accelerometers, operatively coupled to touch screen 110 and configured to monitor vibration of touch screen 110. In other implementations, ultrasonic sensors 120 may include microphones configured to monitor acoustic signals emitted by touch screen 110 upon excitation by ultrasonic emitter 115.

As will be described below, changes in the vibrational frequency of touch screen 110, at portions proximate to ultrasonic sensors 120, may be used to calculate the position of object(s) contacting touch screen 110, to thereby enable interaction with terminal 100. For example, in an ultrasonic implementation, ultrasonic sensors 120 may monitor changes in resonance frequency and/or distortion caused by contact on touch screen 110 and correlate these changes to a location associated with the contact.

As illustrated in FIG. 1, in one implementation consistent with embodiments described herein, touch screen 110 may be provided in a substantially rectangular configuration and ultrasonic sensors 120 may be provided proximate to corners of touch screen 110 for monitoring changes in vibration in corresponding portions of touch screen 110. In other implementations, ultrasonic sensors 120 may be distributed over an entire length and width of touch screen 110, or in other configurations

Control keys 125 may include buttons that permit a user to interact with terminal 100 to cause terminal 100 to perform an action, such as to display a text message via touch screen 110, raise or lower a volume setting for speaker 130, interact with or initiate execution of an application on terminal 100, etc.

Speaker 130 may include a device that provides audible information to a user of terminal 100. Speaker 130 may be located in an upper portion of terminal 100 and may function as an ear piece when a user is engaged in a communication session using terminal 100. Speaker 130 may also function as an output device for music and/or audio information associated with games and/or video images played on terminal 100.

Microphone 135 may include a device that converts speech or other acoustic signals into electrical signals for use by terminal 100. Microphone 135 may be located proximate to a lower side of terminal 100 and may be configured to convert spoken words or phrases into electrical signals for use by terminal 100.

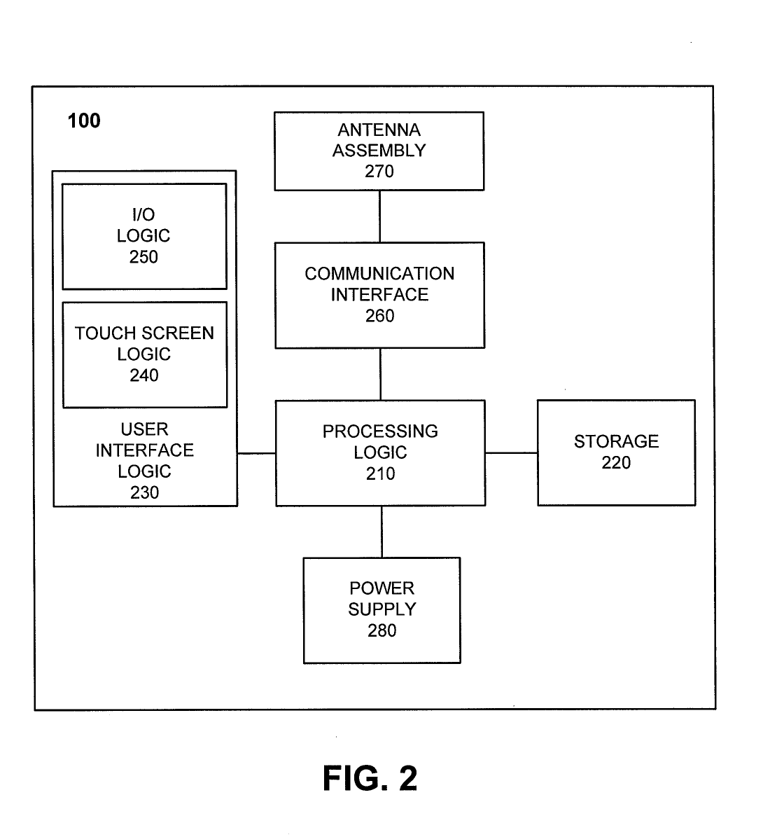

FIG. 2 illustrates an exemplary functional diagram of mobile terminal 100 consistent with the principles described herein. As shown in FIG. 2, terminal 100 may include processing logic 210, storage 220, user interface logic 230, touch screen logic 240, input/output (I/O) logic 250, communication interface 260, antenna assembly 270, and power supply 280.

Processing logic 210 may include a processor, microprocessor, an application specific integrated circuit (ASIC), field programmable gate array (FPGA), or the like. Processing logic 210 may include data structures or software programs to control operation of terminal 100 and its components. Implementations of terminal 100 may use an individual processing logic component or multiple processing logic components (e.g., multiple processing logic 210 devices), such as processing logic components operating in parallel. Storage 220 may include a random access memory (RAM), a read only memory (ROM), a magnetic or optical disk and its corresponding drive, and/or another type of memory to store data and instructions that may be used by processing logic 210.

User interface logic 230 may include mechanisms, such as hardware and/or software, for inputting information to terminal 100 and/or for outputting information from terminal 100. In one implementation, user interface logic 230 may include touch screen logic 240 and input/output logic 250.

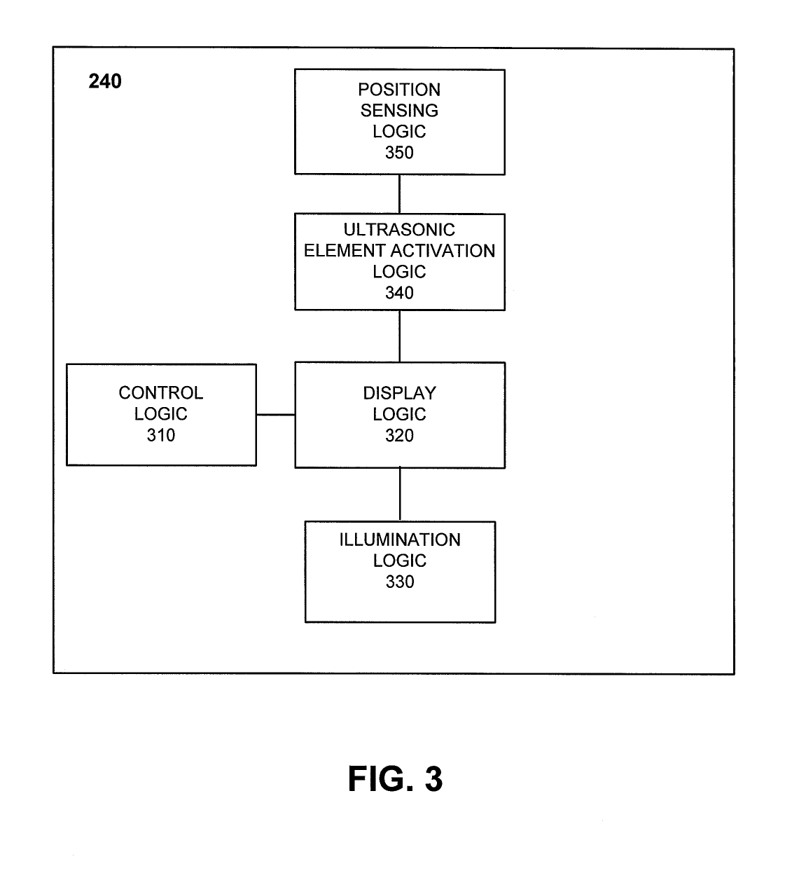

Touch screen logic 240 may include mechanisms, such as hardware and/or software, used to control the appearance of graphical elements on touch screen 110 and to receive user inputs via touch screen 110. For example, touch screen logic 240 may change displayed information associated with graphical elements 140 using an LCD display provided in conjunction with touch screen 110. In some implementations, touch screen logic 240 may be application controlled and may automatically re-configure the appearance of graphical elements 140 based on an application being launched by the user of terminal 100, the execution of a function associated with a particular application/device included in terminal 100 or some other application or function specific event. In addition, touch screen logic 240 may include mechanisms for identifying one or more contact locations corresponding to user interaction with terminal 100. Touch screen logic 240 is described in greater detail below with respect to FIG. 3.

Input/output logic 250 may include hardware or software to accept user inputs to make information available to a user of terminal 100. Examples of input and/or output mechanisms associated with input/output logic 250 may include a speaker (e.g., speaker 130) to receive electrical signals and output audio signals, a microphone (e.g., microphone 135) to receive audio signals and output electrical signals, buttons (e.g., control keys 125) to permit data and control commands to be input into terminal 100, and/or a display (e.g., touch screen 110) to output visual information.

Communication interface 260 may include, for example, a transmitter that may convert base band signals from processing logic 210 to radio frequency (RF) signals and/or a receiver that may convert RF signals to base band signals. Alternatively, communication interface 260 may include a transceiver to perform functions of both a transmitter and a receiver. Communication interface 260 may connect to antenna assembly 270 for transmission and reception of the RF signals. Antenna assembly 270 may include one or more antennas to transmit and receive RF signals over the air. Antenna assembly 270 may receive RF signals from communication interface 260 and transmit them over the air and receive RF signals over the air and provide them to communication interface 260.

Power supply 280 may include one or more power supplies that provide power to components of terminal 100. For example, power supply 280 may include one or more batteries and/or connections to receive power from other devices, such as an accessory outlet in an automobile, an external battery, or a wall outlet. Power supply 280 may also include metering logic to provide the user and components of terminal 100 with information about battery charge levels, output levels, power faults, etc.

As will be described in detail below, terminal 100, consistent with the principles described herein, may perform certain operations relating to receiving inputs via touch screen 110 in response to user inputs or in response to processing logic 210. Terminal 100 may perform these operations in response to processing logic 210 executing software instructions of a touch screen configuration/reprogramming application contained in a computer-readable medium, such as storage 220. A computer-readable medium may be defined as a physical or logical memory device.

The software instructions may be read into storage 220 from another computer-readable medium or from another device via communication interface 260. The software instructions contained in storage 220 may cause processing logic 210 to perform processes that will be described later. Alternatively, hardwired circuitry may be used in place of or in combination with software instructions to implement processes consistent with the principles described herein. Thus, implementations consistent with the principles of the embodiments are not limited to any specific combination of hardware circuitry and software.

FIG. 3 illustrates an exemplary functional diagram of the touch screen logic 240 of FIG. 2 consistent with embodiments described herein. As illustrated, touch screen logic 240 may include control logic 310, display logic 320, illumination logic 330, ultrasonic element activation logic 340, and position sensing logic 350.

Control logic 310 may include logic that controls the operation of display logic 320, and receives signals from position sensing logic 350. Control logic 310 may determine an input command based on the received signals from position sensing logic 350. Control logic 310 may be implemented as standalone logic or as part of processing logic 210. Moreover, control logic 310 may be implemented in hardware and/or software.

Display logic 320 may include devices and logic to present information via touch screen 110, to a user of terminal 100. Display logic 320 may include processing logic to interpret signals and instructions and a display device having a display area to provide information. Implementations of display logic 320 may include a liquid crystal display (LCD) that includes, for example, biphenyl or another stable liquid crystal material. In this embodiment, graphical elements 140 may be displayed via the LCD.

Illumination logic 330 may include logic to provide backlighting to a lower surface of touch screen 110/display logic 320 in order to display information associated with graphical elements 140. Implementations of illumination logic 330 may employ light emitting diodes (LEDs) or other types of devices to illuminate portions of a display device, such as touch screen 110. Illumination logic 330 may provide light within a narrow spectrum, such as a particular color, or via a broader spectrum, such as full spectrum lighting. Illumination logic 330 may also be used to provide front lighting to an upper surface of a display device or touch screen 110 that faces a user. Front lighting may enhance the appearance of touch screen 110 or a display device by making information more visible in high ambient lighting environments, such as viewing a display device outdoors.

Ultrasonic element activation logic 340 may include mechanisms and logic to provide activation energy to one or more ultrasonic emitters 115, which when activated, may ultrasonically vibrate touch screen 110 at a known baseline frequency. For example, ultrasonic element activation logic 340 may receive a signal from control logic 310 to initiate ultrasonic position sensing for touch screen 110. In response to this signal, ultrasonic element activation logic 340 may provide a current and/or voltage to ultrasonic emitters 115, thereby causing ultrasonic emitters 115 and, consequently, touch screen 110 to vibrate at a predetermined frequency.

Position sensing logic 350 may include logic that senses the position and/or presence of one or more objects on touch screen 110 based on the acoustic and/or vibrational state of touch screen 110. Implementations of position sensing logic 340 may be configured to sense the presence and location based on inputs from ultrasonic sensors 120. For example, in one implementation, ultrasonic sensors 120 may include microphones or other devices configured to sense acoustic signals generated by the vibration of touch screen 110.

In one particular embodiment, four ultrasonic sensors 120-A to 120-D (e.g., microphones) may be positioned at spaced locations relative to an entire surface of touch screen 100. Upon vibration of touch screen 110 by ultrasonic emitters 115, ultrasonic sensors 120 may sense an acoustic signal or resonance frequency generated by touch screen 110. Upon contact with touch screen 110, such as by a stylus, finger, or other input device, the resonance frequency and relative distortion sensed by each of ultrasonic sensors 120 may change relative to a position of the contact. Based on a location of the contact, the sensed acoustic changes will be different for each ultrasonic sensor 120. Position sensing logic 350 may receive the frequency information or changes from each ultrasonic sensor 120 and may determine a location of the contact based on the relative changes. In some implementations, position sensing logic 350 may support multi-touches, where multiple discrete contact points on touch screen 110 are distinctly identified.

In another implementation, ultrasonic sensors 120 may include vibration sensors, such as piezo-electric elements configured to directly monitor the vibration of touch screen 110. In this implementation, changes in the resonance frequency of touch screen 110 may cause each piezo-electric element to deform or deflect in an amount corresponding to the vibrational frequency of touch screen 110. A signal corresponding to this deformation or deflection may be output by each ultrasonic sensor (e.g., piezo-electric elements) 120. Position sensing logic 350 may also include logic that sends a signal to control logic 310 in response to detecting and/or calculating the position and/or presence of an object within touch screen 110.

In one implementation, position sensing logic 350 may determine a location (or locations) of a contact point with touch screen 110 by receiving values indicative of changes in measured frequency at each ultrasonic sensor 120 and by triangulating or otherwise combining the information to obtain and accurate determination of contact location. For example, a contact position closer to a given ultrasonic sensor 120 may result in an increased frequency as measured at that ultrasonic sensor 120, similar to the manner in which a shortened guitar string (caused by depression of the string at a fret location) creates a high frequency sound upon vibration of the string. By combining this information for a number of ultrasonic sensors 120, an accurate determination of the contact location may be made.

In an alternative implementation, position sensing logic 350 may store or have access to (e.g., from storage 220) a mapping of frequency values for each ultrasonic sensor 120 corresponding to identified locations on touch screen 110. Upon measurement of a particular set of frequencies, position sensing logic 350 may compare the measure frequencies to the stored mapping and may determine a location of the contact based on the results of the comparison.

Although several exemplary methods have been described above for deriving a contact location on touch screen 110 based on the measurements performed by ultrasonic sensors 120, it should be understood than any suitable methodology may be implemented for deriving the contact point.

Further, although FIG. 1 illustrates ultrasonic emitters 115 and ultrasonic sensors 120 being essentially co-located relative to touch screen 110, it is possible that ultrasonic emitters 115 and ultrasonic sensors 120 may be spaced from each other. Additionally, the number of ultrasonic emitters 115 and ultrasonic sensors 120 illustrated in FIG. 1 are exemplary only. More or fewer ultrasonic emitters 115 and ultrasonic sensors 120 may be provided in accordance with embodiments described herein.

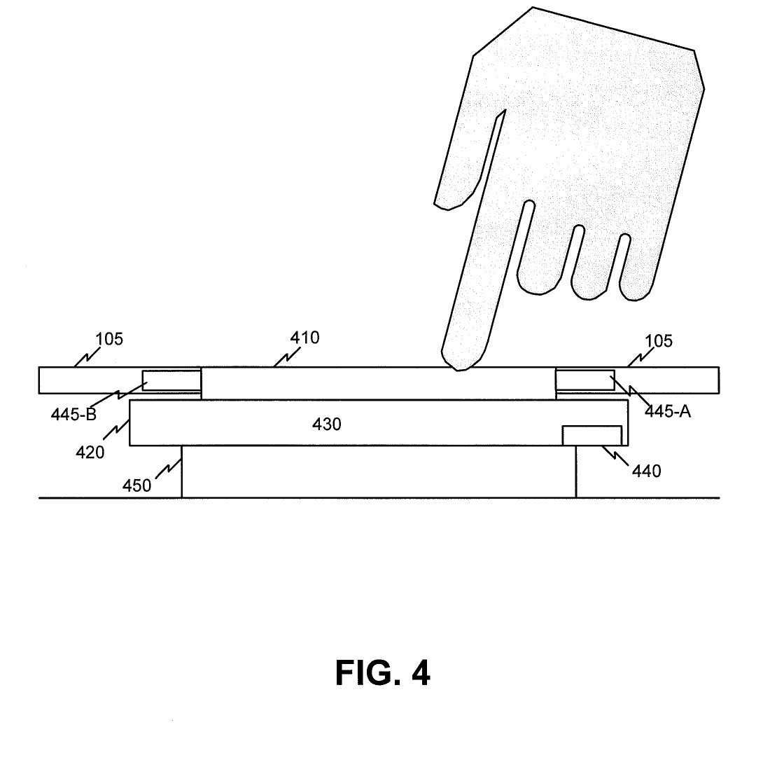

FIG. 4 illustrates an exemplary input system within touch screen 110. As shown, the input system within touch screen 110 may include housing 105, touch sensitive cover 410, enclosure 420, liquid 430, ultrasonic element 440, ultrasonic sensors 445-A and 445-B, and display screen 450.

As described above, housing 105 may include a hard plastic material used to mount components within terminal 100. In one embodiment, touch sensitive cover 410 may be mounted in housing 101 in an area corresponding to touch screen 110. Touch sensitive cover 410 may include a single sheet of glass that may cover components within touch screen 110 (e.g., display screen 450, etc.). In other embodiments, touch sensitive cover 410 may include other materials, such as plastic or composite material. In each case, touch sensitive cover 410 may include a surface, (e.g., a single surface) located over touch screen 110 and forming part of touch screen 110.

Enclosure 420 may include an enclosed area for holding or containing liquid 430 and ultrasonic element 440. For example, enclosure 420 may be formed of a clear plastic material. Enclosure 420 may contact the bottom surface of touch sensitive cover 410 so that vibrations created within enclosure 420 may be transmitted to touch sensitive cover 410.

Liquid 430 may include any type of liquid, such as water, and/or a mixture, etc. Liquid 430 may be used to provide a medium in which to transmit ultrasonic vibrations that may be provided or created by ultrasonic element 440.

Ultrasonic element 440 may include electromechanical mechanisms that produce ultrasonic vibrations, similar to ultrasonic emitters 115 described above. For example, ultrasonic element 440 may receive an electrical signal from ultrasonic element activation logic 340 and may provide/produce an ultrasonic vibration in response to the received signal. Ultrasonic element 440 may include a mechanism such as a piezo-electric element, for example. Ultrasonic element 440 may be included within enclosure 420. When ultrasonic element 440 produces an ultrasonic vibration, the vibration may be transmitted through enclosure 420 to cause touch sensitive cover 410 to vibrate at an initial resonant frequency. In one implementation, vibration of touch sensitive cover 410 at the initial resonant frequency causes touch sensitive cover 410 to emit an acoustic signal that is not audible to humans, such as an ultra high frequency sound. In this exemplary implementation, ultrasonic element 440 is located at the edge of enclosure 420 so as not to obstruct characters displayed via display screen 450. In other exemplary implementations, multiple ultrasonic elements 440 (e.g., as shown in FIG. 1) may be used and may be located at other positions within terminal 100. For example, there may be multiple ultrasonic elements 440 strategically located to provide uniform vibration across an entirety of touch sensitive cover 410. For example, touch screen 110 may be divided into four quadrants, where an ultrasonic element 440 may be located in each quadrant.

Ultrasonic sensors 445-A and 445-B may include electromechanical mechanisms that sense the ultrasonic vibrations present in a corresponding portion of touch sensitive cover 410, similar to ultrasonic sensors 120 described above. For example, as described above, ultrasonic sensors 445-A and 445-B may include microphones configured to sense acoustic signals emitted by touch sensitive cover 410. Contact with touch sensitive cover 410 may cause changes in the acoustic signals (or vibration) sensed by ultrasonic sensors 445-A and 445-B. Ultrasonic sensors 445-A and 445-B may output signals to position sensing logic 350 based on the monitored acoustic or signals or vibrations. Position sensing logic 350 may receive the signals from ultrasonic sensors 445-A and 445-B and may determine a location of the contact based thereon.

Display screen 450 may include an LCD or similar type of display, similar to display 110 described above. Display screen 450 may display characters based on signals received from display logic 320.

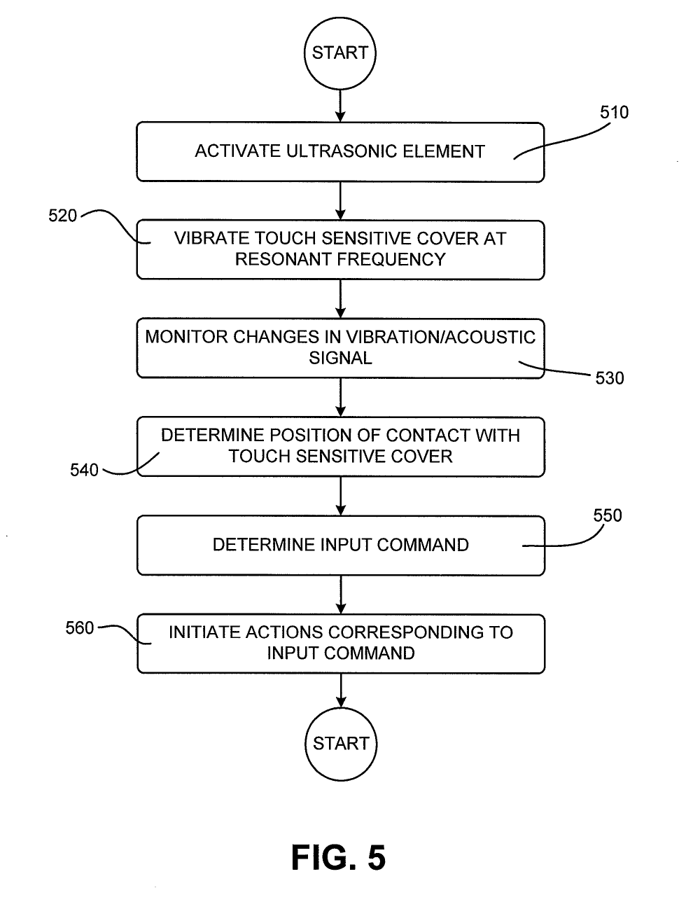

It should be noted that, although FIG. 4 illustrates ultrasonic element 440 and ultrasonic sensors 445 acting on touch sensitive cover 410, it should be apparent that principals consistent with embodiments described herein may apply these elements directly to display screen 450, without requiring enclosure 420, liquid 430, or touch sensitive cover 410. In this manner, vibrations from ultrasonic element 440 may be applied to display screen 450. Corresponding vibrations/acoustic signals from display screen 450 may be monitored by ultrasonic sensors 445. Operation of the input system shown in FIG. 4 is described below with reference to FIG. 5.

FIG. 5 is a flowchart of exemplary processing consistent with the principles described herein. Terminal 100 may provide a touch screen 110 configuration as shown in FIG. 1. Process 500 may begin upon activation of ultrasonic element(s) 440 to cause ultrasonic vibration of touch sensitive cover 410 (or, alternatively, display screen 450) of touch screen 110 (block 510). In one implementation, activation of one or more of control keys 125 may be required to activate ultrasonic elements 440. As described above, control logic 310 may output an electrical signal to ultrasonic element activation logic 340 to initiate vibration of ultrasonic element(s) 440.

In response to activation of ultrasonic element(s) 400, touch sensitive cover 410 (or, alternatively, display screen 450) may vibrate at a resonant frequency to emit an ultrasonic acoustic signal (block 520). Position sensing logic 350 may monitor changes in the vibration or emitted ultrasonic/acoustic signal at one or more locations within touch sensitive cover 410 (or, alternatively, display screen 450) (block 530). For example, as described above, ultrasonic sensors 445-A and 445-B may include microphones configured to monitor acoustic signals generated at various portions of touch sensitive cover 410 (or, alternatively, display screen 450). Position sensing logic 30 may determine an existence and location of a contact with touch sensitive cover 410 (or, alternatively, display screen 450) based on the sensed acoustic signals (block 540).

Upon determining the location of a contact on touch sensitive cover 410 (or, alternatively, display screen 450), a corresponding input command may be determined (block 550). For example, if the position of a user's finger or other input device corresponds to a location of a “mail” icon or graphical element 140 associated with electronic mail on touch screen 110, position sensing logic 350 may determine that the “mail” icon has been selected by the user.

In response to determining the input command (block 550), one or more actions corresponding the determined input may be initiated (block 560). For example, if position sensing logic 350 determines that a “mail” icon has been selected, a signal may be sent to display logic 320 and control logic 310 in order to open or launch an electronic mail application on terminal 100. Alternatively, additional actions may occur simultaneously, such as a checking of external mail resources, e.g., via communication interface 260, etc.

### CONCLUSION

Implementations consistent with the principles described herein may determine contact location with a touch screen based on vibrational characteristics. More specifically, acoustic signals and/or vibrations in a touch screen may be initiated. Changes in the acoustic signals and/or vibrations caused by contact with the touch screen may be monitored and processed to determine a location of the contact. By using ultrasonic or acoustic signals to determine a contact position, durable (e.g., scratch-proof/resistant) and multi-use materials may be used. In addition, the touch screen may be formed without adding significant thickness to the display.

The foregoing description of the embodiments provides illustration and description, but is not intended to be exhaustive or to limit the embodiments to the precise form disclosed. Modifications and variations are possible in light of the above teachings or may be acquired from practice of the embodiments.

While a series of acts has been described with regard to FIG. 5, the order of the acts may be modified in other implementations consistent with the principles of the embodiments. Further, non-dependent acts may be performed in parallel.

It will be apparent to one of ordinary skill in the art that aspects of the embodiments, as described above, may be implemented in many different forms of software, firmware, and hardware in the implementations illustrated in the figures. The actual software code or specialized control hardware used to implement aspects consistent with the principles of the embodiments is not limiting of the embodiments. Thus, the operation and behavior of the aspects were described without reference to the specific software code—it being understood that one of ordinary skill in the art would be able to design software and control hardware to implement the aspects based on the description herein.

Further, certain portions of the embodiments may be implemented as “logic” that performs one or more functions. This logic may include hardware, such as hardwired logic, an application specific integrated circuit, a field programmable gate array or a microprocessor, software, or a combination of hardware and software.

It should be emphasized that the term “comprises/comprising” when used in this specification and/or claims is taken to specify the presence of stated features, integers, steps or components but does not preclude the presence or addition of one or more other features, integers, steps, components or groups thereof.

No element, act, or instruction used in the present application should be construed as critical or essential to the embodiments unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. An assembly, comprising:
a touch screen;
a first element to cause the touch screen to vibrate at a predetermined frequency;
a first sensor proximate to a first portion of the touch screen for measuring vibration in the first portion of the touch screen;
a second sensor proximate to a second portion of the touch screen for measuring vibration in the second portion of the touch screen; and
position sensing logic for determining a position of a contact point on the touch screen based on the measured vibration in the first portion of the touch screen and the measured vibration in the second portion of the touch screen.

2. The assembly of claim 1, where the first element causes the touch screen to emit an acoustic signal in response to the vibrating at the predetermined frequency, and where the first sensor and the second sensor comprise microphones for monitoring the acoustic signal.

3. The assembly of claim 1, where the first element comprises a piezo-electric element configured to deform based on a control signal.

4. The assembly of claim 1, where the first sensor and the second sensor comprise piezo-electric elements configured to output signals based on deformation caused by the vibration of the touch screen.

5. The assembly of claim 1, where the touch screen further comprises:
a display screen;
an enclosure that contains a liquid and the first element; and
a touch sensitive cover,
where the first sensor and the second sensor are provided proximate to respective portions of the touch sensitive cover.

6. The assembly of claim 5, further comprising:
a third sensor; and
a fourth sensor,
where the touch screen is provided in a substantially rectangular configuration and where the first sensor, second sensor, third sensor, and fourth sensor are provided proximate to corners of the touch screen.

7. The assembly of claim 5, where the first element produces an ultrasonic wave through the liquid to vibrate the touch sensitive cover at the predetermined frequency.

8. The assembly of claim 5, where the position sensing logic is further configured to: determine a position of a contact point on the touch sensitive cover.

9. The assembly of claim 8, where the position sensing logic is further configured to output a signal to processing logic based on the determined position of the contact point on the touch sensitive cover.

10. A method, comprising:
causing a touch screen to vibrate at a predetermined frequency;
monitoring changes in vibration at a first portion of the touch screen and a second portion of the touch screen; and
determining a location of a contact on the touch screen based on the monitored changes.

11. The method of claim 10, where causing a touch screen to vibrate at a predetermined frequency further comprises:
receiving a command to activate an ultrasonic element associated with the touch screen; and
activating the ultrasonic element in response to the command.

12. The method of claim 10, where the ultrasonic element comprises a piezo-electric element.

13. The method of claim 10, where the predetermined frequency causes the touch screen to emit an acoustic signal, and
where the monitoring changes in vibration at a first portion of the touch screen and a second portion of the touch screen further comprises:
monitoring changes in the acoustic signal at the first portion and the second portion.

14. The method of claim 10, where monitoring changes in vibration at a first portion of the touch screen and a second portion of the touch screen further comprises:
coupling a first sensor proximate to the first portion;
coupling a second sensor proximate to the second portion;
deflecting the first sensor and the second sensor based on the vibration of the touch screen; and
outputting signals based on the deflecting of the first sensor and the second sensor.

15. A device, comprising:
a display assembly comprising:
a display screen;
an enclosure that contains a liquid;
a top surface provided in contact with the enclosure;
an ultrasonic element provided within the enclosure; and
a plurality of ultrasonic sensors located proximate to portions of the top surface; and
logic configured to:
activate the ultrasonic element to produce a vibration in the top surface via the liquid;
monitor vibration of the portions of the top surface by the sensors;
determine a location of a contact on the top surface based on the monitored vibration; and
use the determined location to interact with the device.

16. The device of claim 15, where the vibration in the top surface causes the top surface to output an acoustic signal, and
where the plurality of ultrasonic sensors further comprise a plurality of microphones configured to monitor changes in the acoustic signal output by the top surface.

17. The device of claim 15, where the ultrasonic element comprises a piezo-electric element.

18. The device of claim 15, where the plurality of ultrasonic sensors comprise a plurality of piezo-electric sensors.

19. The device of claim 15, where the top surface includes a substantially rectangular configuration and where the plurality of ultrasonic sensors further comprise:
a first sensor provided proximate a first corner of the top surface;
a second sensor provided proximate a second corner of the top surface;
a third sensor provided proximate a third corner of the top surface; and
a fourth sensor provided proximate a fourth corner of the top surface.

20. The device of claim 19, where the logic is further configured to determine the location of one or more points of contact on the top surface based on the vibration monitored by the first sensor, the second sensor, the third sensor, and the fourth sensor.
